(19) United States
(12) Patent Application Publication
(10) Pub. No.: US 2013/0089748 A1
(43) Pub. Date: Apr. 11, 2013

(54) THE SUBSTANTIALLY FORMALDEHYDE-FREE LAMINATES AND METHODS FOR MANUFACTURING SUBSTANTIALLY FORMALDEHYDE-FREE LAMINATES

(71) Applicants: Frederic Auguste Taillan, Cincinnati, OH (US); Kevin Francis O'Brien, Cincinnati, OH (US)

(72) Inventors: Frederic Auguste Taillan, Cincinnati, OH (US); Kevin Francis O'Brien, Cincinnati, OH (US)

(73) Assignee: THE DILLER CORPORATION, Cincinnati, OH (US)

(21) Appl. No.: 13/269,851

(22) Filed: Oct. 10, 2011

(51) Int. Cl. B32B 29/00; B32B 38/08

(52) U.S. Cl. 428/535; 156/273.3

(57) ABSTRACT

Embodiments of the present invention are directed to substantially formaldehyde-free laminates and methods of making substantially formaldehyde-free laminates, wherein the method comprises providing at least one layer of decorative paper; applying at least one polymer coating that is substantially formaldehyde free onto at least one surface of the decorative paper; electron beam curing the at least one polymer coating onto the decorative paper; providing one or more layers of core paper onto the coated decorative paper, wherein the core paper is impregnated with a resin that is substantially formaldehyde free; and hot pressing the core paper and coated decorative paper to form the substantially formaldehyde-free laminate.

### TECHNICAL FIELD

The present invention generally relates to decorative laminates, and specifically relates to decorative laminates that are substantially formaldehyde free and methods for manufacturing such laminates for use as decorative surfacing materials for countertops, cabinets, furniture, wall coverings, and other applications.

### BACKGROUND

Decorative laminates may be used as surfaces for countertops, cabinets, furniture, wall coverings, and other applications. Such decorative laminates may be comprised of a core, formed from a plurality of kraft paper sheets which are impregnated with a phenolic resin. Positioned above the core may be a decorative sheet which is typically a pigmented cellulose paper containing a printed pattern design, or alternatively a solid color paper, which may also be impregnated with a resin, such as a melamine-formaldehyde resin, or modified melamine-formaldehyde resin, generically referred to as a “melamine resin.” Such decorative laminates, due in part to the use of phenolic and melamine resins during manufacturing, may emit formaldehyde, which has been classified as a known human carcinogen by the International Agency for Research on Cancer and as a probable human carcinogen by the U.S Environmental Protection Agency.

The present invention may address one or more of the problems and deficiencies related to decorative laminates; however, it is contemplated that the invention may prove to be useful in addressing other problems and deficiencies in a number of technical areas. The claimed invention should not be construed to be limited to addressing any of the particular problems or deficiencies discussed herein.

### SUMMARY

In one embodiment, a method of making a substantially formaldehyde-free laminate is provided. The method comprises providing at least one layer of decorative paper, wherein the decorative paper is substantially formaldehyde free; applying at least one polymer coating that is substantially formaldehyde free onto at least one surface of the decorative paper; electron beam curing the at least one polymer coating onto the decorative paper; providing one or more layers of core paper onto the coated decorative paper, wherein the core paper is impregnated with a resin that is substantially formaldehyde free; and hot pressing the core paper and coated decorative paper to form the substantially formaldehyde-free laminate.

In another embodiment, another method of making a substantially formaldehyde-free laminate is provided. The method comprises providing a layer of decorative paper, wherein the decorative paper is substantially formaldehyde free; pretreating the decorative paper by impregnating it with a thermoset resin composition that is substantially formaldehyde free; applying at least one polymer coating that is substantially formaldehyde free onto at least one surface of the pretreated decorative paper; electron beam curing the at least one polymer coating onto the at least one surface of the decorative paper; providing one or more layers of core paper, wherein the core paper is impregnated with an epoxy resin and substantially formaldehyde free; and hot pressing the core paper and coated decorative paper to form the substantially formaldehyde-free laminate.

In another embodiment, a substantially formaldehyde-free laminate is provided. The substantially formaldehyde-free laminate comprises at least one layer of decorative paper substantially free of formaldehyde and impregnated with a substantially formaldehyde-free thermoset resin; one or more layers of kraft paper disposed on an inner surface of the decorative paper, wherein the kraft paper is impregnated with an resin that is substantially formaldehyde free; and an electron beam cured polymer coating that is substantially formaldehyde free disposed on an outer surface of the decorative paper, wherein the electron beam cured polymer coating is an outermost layer of the substantially formaldehyde-free laminate.

The features and advantages of the present invention will become apparent from the following description.

### BRIEF DESCRIPTION OF THE DRAWINGS

The following detailed description of specific embodiments of the present invention can be best understood when read in conjunction with the following drawings, where like structure is indicated with like reference numerals and in which:

FIG. 1 is a cross-sectional view of one embodiment of the decorative laminate of the present invention;

FIG. 2 is a cross-sectional view of another embodiment of the decorative laminate of the present invention;

FIG. 3 is a cross-sectional view of one embodiment of the decorative laminate of the present invention bonded to a substrate material, thus forming a final panel assembly of the present invention; and

FIG. 4 is a schematic illustration of a method of making one embodiment of the decorative laminate of the present invention.

FIG. 5 is a schematic illustration of another method of making another embodiment of the decorative laminate of the present invention.

FIG. 6 is a schematic illustration of another method of making another embodiment of the decorative laminate of the present invention.

The present invention relates to decorative laminates that are substantially formaldehyde free and methods for manufacturing such laminates. A substantially formaldehyde-free laminate, as used herein, is a laminate that may have trace amounts of formaldehyde emission, but that contributes airborne formaldehyde at levels that are not greater than the levels found in the natural outdoor environment. Formaldehyde occurs naturally in the environment and is even produced in small amounts by most living organisms, including plants and animals. Thus “formaldehyde-free” does not mean that there can be no formaldehyde emitted. One standard for declaring products to be “formaldehyde free” has been propounded by the GREENGUARD Environmental Institute. The GREENGUARD Environmental Institute may declare a product or material to be declared formaldehyde free if it has a formaldehyde emission factor of less than or equal to 5 μg/m² hr at 24 elapsed exposure hours, which corresponds to a measured chamber concentration of 2.5 μg/m² hr for a typical loading ratio of 0.5 m²/m³. The formaldehyde emissions of the laminates of the present invention may be measured by following the testing requirements used by GREENGUARD and found in GGTM.P066, “Standard Method for Measuring and Evaluating Chemical Emissions from Building Materials, Finishes, and Furnishings using Dynamic Environmental Chambers.” The substantially formaldehyde-free laminates may include less than about 0.01 ppm of formaldehyde, or less than about 0.001 ppm formaldehyde, or zero formaldehyde. In the methods of manufacture of the substantially formaldehyde-free laminates of this invention, no formaldehyde, no formaldehyde precursors, and no formaldehyde polymers are added. No formation of formaldehyde is expected under typical product usage conditions.

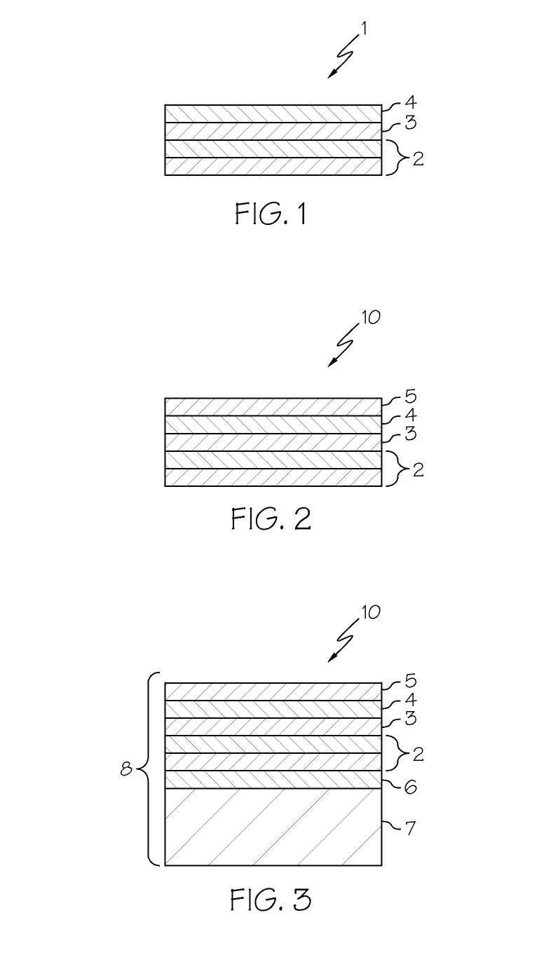

Referring initially to FIG. 1, one embodiment of the substantially formaldehyde-free laminate 1 of the present invention is shown. The laminate 1 comprises a core 2, a decorative paper 3 that may be impregnated with a thermoset resin, and an electron beam cured polymer coating 4 on the decorative paper 2. As shown, the core 2 of the laminate 1 is comprised of one or more layers of paper sheets, such as kraft paper, which may be impregnated with a resin that is substantially formaldehyde free. The cores provide reinforcing structural bases to the laminates.

Referring now to FIG. 2, another embodiment of the substantially formaldehyde-free laminate 1 of the present invention is shown. The laminate 1 comprises a core 2, a decorative paper 3 that may be impregnated with a thermoset resin, and electron beam cured polymer coating 4 and 5 on the decorative paper 2.

FIG. 3 illustrates an embodiment of the substantially formaldehyde-free decorative laminate 1 of the present invention, in which said laminate has been bonded by means of a suitable adhesive 6 to a substrate material 7, thus forming a bonded panel assembly 8.

Referring to FIGS. 1-3, the decorative paper 3 may be a sheet having a pigmented solid color and may comprise α-cellulose fibers, which have had incorporated therein colored pigments during the papermaking process. Other suitable fiber compositions are contemplated herein. As will be appreciated, a variety of different pigmented colors are possible. Such pigmented solid color papers typically vary from about 65 to 146 gsm (about 40 to 90 pounds/3MSF) basis weight, which weight is largely dependent on the color and opacity of the paper. Alternatively, the decorative paper sheet may have a printed design on its uppermost surface and oriented facing away from the laminate core so that the design is visible in the final pressed product. The print sheet base paper may comprise α-cellulose fibers having one or more fillers and various pigments which have been added during the papermaking process. The print pattern design may be applied to one side of the base paper using a multi-station rotogravure printing process, and can be a woodgrain, mineral or stone, ceramic, metal, leather or abstract design. Print papers may vary in basis weight from about 50 to about 105 gsm, or about 30 to about 65 pounds/3MSF, depending on the base paper color, the overall print tone, ink coverage, and opacity of the printed paper.

The decorative paper 3 may be pretreated by impregnating it, as described later herein, with a thermoset resin composition that is substantially formaldehyde free. In some embodiments, the thermoset resin composition may include about 3% to about 30% by weight of epoxy, vinyl ester, or urethane. The thermoset resin composition may be modified by the addition of plasticizers and surfactants so that the liquid composition more readily wets and penetrates into the decorative paper 3.

The decorative paper 3 has at least one polymer coating that is substantially formaldehyde free on the outer surface of the decorative paper 3. As described later herein, the at least one polymer coating is electron beam cured onto the decorative paper 3. In the embodiment shown in FIG. 1, the laminate 1 includes one electron beam curable polymer coating 4 that is disposed on the outside surface of the decorative paper 3. In the embodiments shown in FIGS. 2 and 3, the laminate 1 includes a first electron beam curable polymer coating 4 and a second electron beam curable polymer coating 5. The one or more polymer coatings may include the same or different compositions. The polymer coating may comprise from about 10 to about 75 grams per square meter (gsm) of thermoset acrylic, urethane, or combinations thereof. It may comprise a thermoplastic copolymer resin that is substantially formaldehyde-free. Examples of suitable thermoplastic resins for use in the polymer coating include (ABS), (PMMA), (COC), (EVA), (EVOH), (PTFE, alongside with FEP, PFA, CTFE, ECTFE, ETFE), (PTFE, alongside with FEP, PFA, CTFE, ECTFE, ETFE), (POM or Acetal), (Acrylic), (PAN or Acrylonitrile), (PA or Nylon), (PAI), (PAEK or Ketone), (PBD), (PB), (PBT), (PCL), (PCTFE), (PET), Polycyclohexylene dimethylene terephthalate (PCT), (PC), (PHAs), (PK), (PE), (PEEK), (PEKK), (PEI), (PES), Chlorinated Polyethylene (CPE), (PI), (PLA), (PMP), (PPO), (PPS), (PPA), (PP), (PS), (PSU), (PTT), (PU), (PVA), (PVC), (PVDC), (SAN), Polysiloxanes.

Abrasive particles, such as aluminum oxide, can optionally be incorporated into the papermaking process, or alternatively, in the one or more polymer coatings, to further enhance the surface wear properties such as abrasion, scratch and mar resistance of the laminate. These abrasive parties may range in size from about 0.5 to 50 microns in diameter, or about 3 to about 25 microns in diameter. In some embodiments, deposition concentrations on or in the decorative paper may range from about 0.5 to 5 grams per square meter. A polymer coating resin composition comprising aluminum oxide may be prepared by mixing, with continual agitation, the alumina powder into the solution to evenly disperse the alumina particles. Additionally, a thickening agent such as sodium alginate, carboxymethyl cellulose, or the like, may be advantageously incorporated in the resin solution to aid with suspension of the alumina dispersion.

As shown in FIGS. 1-3, the core 2 of the laminates 1 provides a reinforcing structural base to the laminate. The core 2 may be comprised of one or more layers of paper sheets, such as kraft paper. In some embodiments, the core may comprise from about 2 to about 20 sheets of paper. The core papers will typically vary in basis weight from about 80 up to about 250 grams per square meter (gsm), or from about 50 up to about 150 pounds per 3000 square feet (ream). In some embodiments, the core may comprise one or more layers of saturating grade kraft paper having a basis weight of about 70 to about 150 pounds/3MSF. In some embodiments, the core may comprise regular saturating kraft from KapStone, International Paper or Kotkamills.

Prior to lamination, the core paper is impregnated with a substantially formaldehyde-free resin. Typically, the resin will be a liquid resin in an aqueous solution having a solids content of from about 40 to about 70% and a water content of from about 30 to about 60%. As those versed in the art will appreciate, the use of aqueous resin solutions to impregnate the core paper may require use of core papers with a greater amount of a wet strength agent to insure satisfactory handleability without excessive web breaks during the treating operation. Suitable wet strength agents may include epoxidised polyamide resins, polethylenimine, and glyoxalated polyacrylamide resin. In some embodiments, the core resin may be the same resin which is used to impregnate the decorative paper. For example, the core resin may comprise an epoxy resin, urethane resin, an acrylic resin, or combinations thereof. Modification of the resin with a suitable “internal” and/or “external” plasticizer and/or diluent may improve the finished laminate flexibility, stress crack resistance, and postforming characteristics, as is known by those skilled in the art.

The core papers are normally treated, i.e., impregnated and partially dried, to a resin content of from about 25% up to about 45%, with a residual volatile content of from about 4% up to about 10%. As used herein, the term “resin content” is defined as the difference in weight of a given area of the treated paper and the initial untreated paper, divided by the weight of the treated paper and expressed as a percentage. Similarly, as used herein, the term “volatile content” is defined as the difference in weight of a given area of the treated paper and the same treated paper sample after complete drying at 165° C. for 5 minutes, divided by the weight of the treated paper and expressed as a percentage. According to one embodiment of the present invention, a Mead/Westvaco 158 gsm (97 lb./ream) pigmented core paper, with a moisture content of about 2% and an ash content of about 25%, is treated to about 40% resin content and 5% volatile content for subsequent use in the core 2 of the substantially formaldehyde-free decorative laminate of the present invention.

In some embodiments of the present invention, the overall thickness of the substantially formaldehyde-free laminate 1 may be any thickness sufficient to achieve the desired stress crack resistance and the desired postformability properties. In one or more embodiments, the overall thickness may be from about 0.3 to about 1.5 mm.

The finished laminate 1, after edge trimming and back sanding, can be bonded, using a suitable adhesive, to a substrate selected from materials such as medium density fiberboard, particleboard, plywood, oriented strand board, wafer board, mineral fiber cement board, or the like. This bonding imparts mechanical strength to the decorative laminate in final panel assembly form. The finished substantially formaldehyde-free laminate product provides the toughness, moisture resistance, stain resistance, impact resistance, and abrasion resistance of a conventional melamine formaldehyde laminated product. The finished laminate product may be postformed by heating the laminate and forming at least a portion of the laminate around a forming mold. The laminate product may be so postformed without causing delamination of the product, or cracking of the decorative surface.

Referring now again to FIG. 3, a substantially formaldehyde-free laminate 1 according to some embodiments of the present invention is bonded using a suitable adhesive 6 to a suitable substrate 7. The suitable adhesive 6, which is typically brushed, rolled or sprayed on to the sanded back of the decorative laminate 1 and/or the opposed surface of the substrate 7, may include neoprene-based contact adhesives, catalyzed or uncatalyzed polyvinylacetate (PVAc) cold or hot press adhesives, or thermosetting adhesives such as urea-formaldehyde or phenol-resorcinol-hexamethylenetetraamine adhesives, depending on the final end-use panel application. Preferred substrate materials 7 include 45 pound/ft³ particleboard, medium density fiberboard (MDF) or cement fiberboard, again depending on the panel assembly end-use performance requirements. Other types of substrates, for example fire-rated particleboard, aluminum, steel, fiber reinforced polyester (FRP), and honeycomb sheet materials, may also be used for more specialized applications.

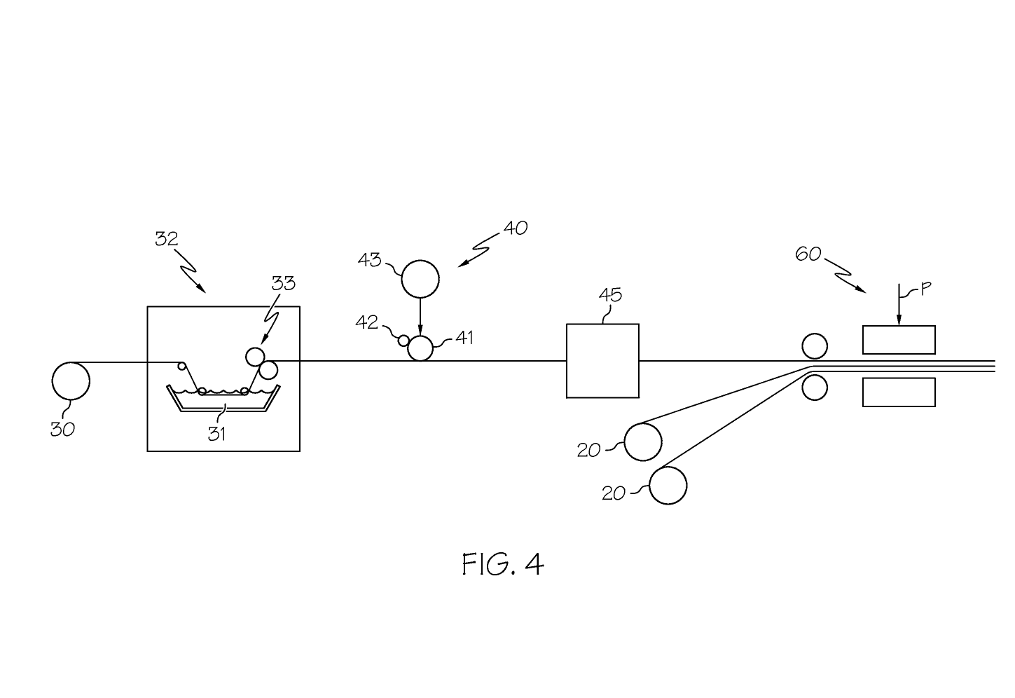

FIG. 4 illustrates one method of making a substantially formaldehyde-free laminate of one embodiment of the present invention. While shown as a substantially continuous process, it is also possible that individual components in the laminate may be prepared at separate times, and even at separate locations, prior to being pressed into the final laminate product. Also, as indicated below, the components of the laminate may be cut into sheets at any time during manufacture.

As shown in FIG. 4, a continuous web of decorative paper 30 is pretreated with a thermoset resin 31 at a treating station 32. Several impregnation or treating methods may be used. According to the embodiment shown in FIG. 4, the bottom, non-decorative side of the decorative paper is allowed to contact and be flooded by a thermoset resin composition that is substantially formaldehyde free. While not wishing to be bound by any particular theory, it is believed that the thermoset resin penetrates substantially the entire volume of the decorative sheet through a capillary action mechanism. Alternatively, the decorative paper may be immersed in a bath of thermoset resin, such that the thermoset resin is allowed to penetrate and impregnate the decorative paper.

The decorative paper pretreatment is followed by passing the impregnated paper through a set of metering rolls 33, whose nip is adjusted to control the paper's liquid resin pick-up. Optionally, this pretreating also may be followed by at least partial drying in an oven (not shown), which is typically a recirculated hot air heated oven.

The pretreated decorative paper continues to coating station 40, which may include infeed and outfeed conveyors, an applicator roll 41 having an adjustable position, and a variable pressure doctor roll 42 to meter the liquid resin on the applicator rolls and therefore control the resin application rate. The applicator roll 41 is positioned to apply a polymer coating to the top surface of the decorative paper. At coating station 40, a first electron beam curable polymer resin is supplied to the applicator roll from resin sources 43. In one embodiment, the applicator roll comprises a polyurethane foam surfaced stainless steel roll, and the doctor roll comprises a knurled chrome-plated stainless steel roll. The applicator roll at coating station 40 applies the first electron beam curable polymer coating to the pretreated decorative paper 30, with the total quantity of liquid resin deposition being, in some embodiments, about 10 to about 75 gsm.

After the decorative paper has gone through the coating station 40 and has been coated with an electron beam curable polymer resin, the coated decorative paper proceeds to the electron beam curing station 45. The electron beam curing station 45 utilizes electrons to polymerize and cross-link polymeric materials. Electron beam curing can occur rapidly at ambient temperatures, resulting in time and energy savings. Further, the use of electron beam curing does not require catalysts to be added to the polymer coating. As a result, laminates of certain embodiments of the present invention may be substantially free of catalysts in the outer layer of the laminate and therefore may be less chemically reactive than laminates in which such catalysts are present.

Upon exiting the electron beam coating station 45, the decorative paper 30 may be combined with one or more webs of core paper 20 that have been impregnated with a resin that is substantially formaldehyde free. The layer of decorative paper 30 and layers of core paper 20 proceed through a continuous press 60. Under sufficient pressure and heat, the resins in the individual laminate layers flow, cure and bond together, forming the consolidated, unitary substantially formaldehyde-free laminate 1 in accordance with an embodiment of the present invention. In some embodiments, the decorative paper 30 and core paper 20 are subject to pressure of about 300 to about 1100 psi and temperatures of about 130 to 190° C.

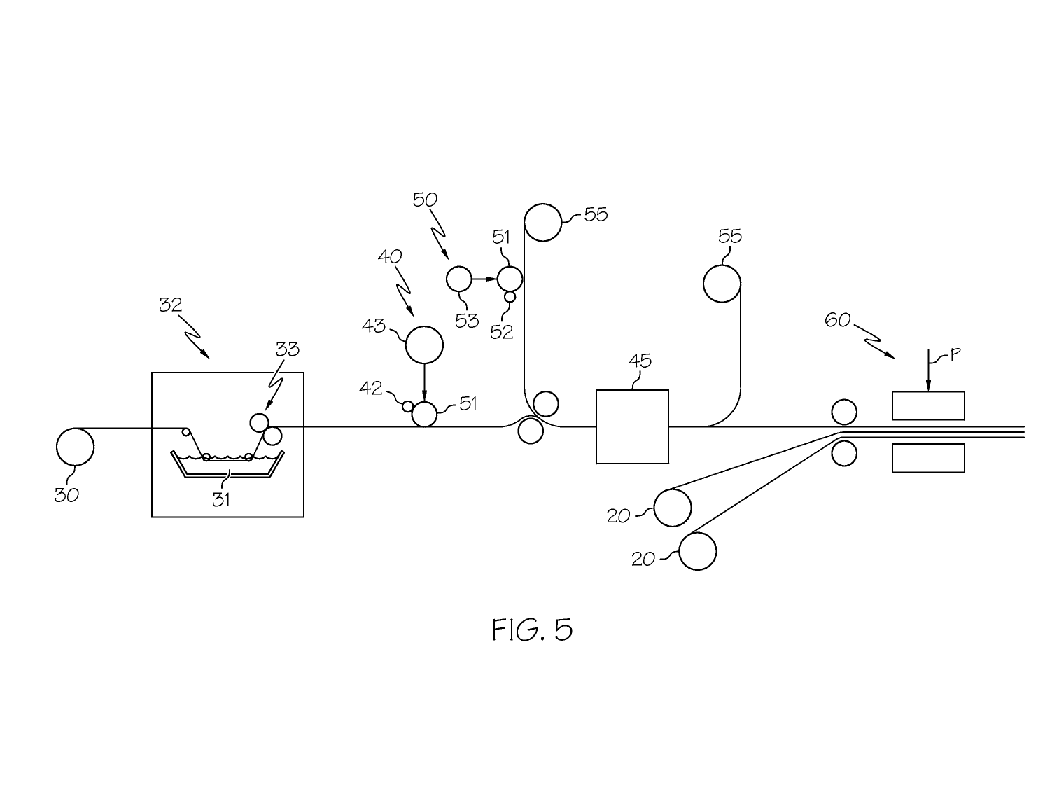

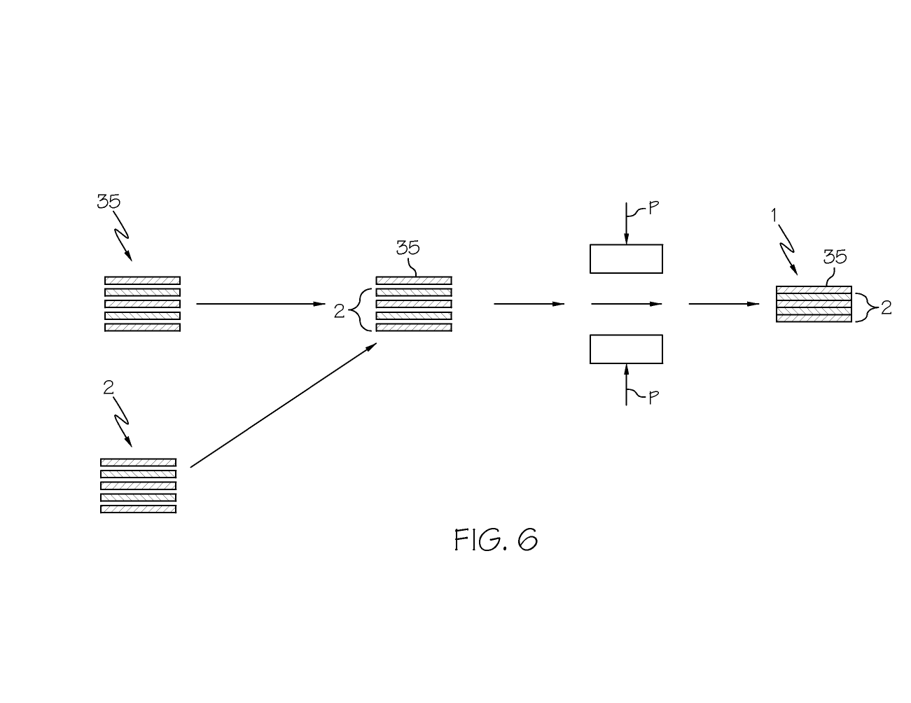

The methods depicted in FIG. 4 and FIG. 5 each combine webs of impregnated core paper with a web of coated and electron beam cured decorative paper. Alternatively, multiple sheets of core 2 may be formed by impregnating a continuous web of kraft or other selected paper, as described above, with a liquid resin at treating station, followed by at least partial drying in an oven, which is typically a recirculated hot air heated oven. The impregnated and partially dried core paper web may then be cut to size, and the core sheets stacked. As shown in FIG. 6, sheets of resin impregnated, coated, and electron beam cured decorative paper 35 may be laminated to core 2 sheets by positioning the decorative paper 35 and the core 2 sheets between a pair of press plates and applying pressure thereto. The press plates are then heated under pressure to a predetermined temperature for sufficient time to cure the first and second resins, as well as the core resin, such pressing process being well understood by those versed in the art. The application of heat and pressure, typically employing a flat bed hydraulic press of one or more openings, equipped with heating/cooling platens, causes the resins to flow and bond all of the layers of the laminate together to form a strong, unitary product.

It will be understood by those skilled in the art that the optimum press cycle time and temperature is governed by the cure rate kinetics of the resins employed. The pressed finished laminate product should meet certain minimum physical property standards indicating commercially acceptable laminate surface and core cure, and interlaminar bond integrity, for horizontal postforming grade HGP product. These performance standards are defined by the National Electrical Manufacturers Association (NEMA) in their Standards Publication LD 3-2005 (as approved by the American National Standards Institute (ANSI)), and include boiling water resistance (LD 3-3.5), high temperature resistance (LD 3-3.6), radiant heat resistance (LD 3-3.10), and blister resistance (LD 3-3.15), as well as those properties where the present invention exhibits substantial improvement over wood veneer surfaced laminate products of the prior art, including scratch resistance (LD 3-3.7), impact resistance (LD 3-3.8), wear (abrasion) resistance (LD 3-3.13), and [post]formability (LD 3-3.14).

Typically, the decorative laminate of the present invention is provided in the form of a sheet having predetermined dimensions as desired. Generally, such sheets have widths of between about 36 to about 72 inches (about 90 to about 185 cm.). When the core paper or the decorative paper is cut into sheets before entering the press, the resulting laminate sheets will generally be limited to lengths of between about 72 and about 144 inches (about 185 to about 370 cm.), conforming to the size of the press plates in use and limited only by the size of the press heating/cooling platens.

FIG. 5 illustrates another method of making a substantially formaldehyde-free laminate of one embodiment of the present invention. Again, while shown as a substantially continuous process, it is also possible that individual components in the laminate may be prepared at separate times, and even at separate locations, prior to being pressed into the final laminate product. Also, as indicated above, the components of the laminate may be cut into sheets at any time during manufacture.

As shown in FIG. 5, a continuous web of decorative paper 30 is pretreated with a thermoset resin 31 at a treating station 32, and the impregnated paper is passed through a set of metering rolls 33, whose nip is adjusted to control the paper's liquid resin pick-up. The pretreated decorative paper continues to coating station 40, at which a first electron beam curable polymer resin is supplied to the applicator roll 41 from resin sources 43.

As shown in FIG. 5, a web of release film 55 (for example, polyester film that is not electron beam curable) may be coated with a second electron beam curable polymer resin at a second coating station 50. The second coating station 50 may include infeed and outfeed conveyors, an applicator roll 51 having an adjustable position, and a variable pressure doctor roll 52 to meter the liquid resin on the applicator rolls and therefore control the resin application rate. The applicator roll 51 is positioned to apply a polymer coating to the top surface of the decorative paper 30. At coating station 50, a first electron beam curable polymer resin is supplied to the applicator roll from resin sources 53. In one embodiment, the applicator roll 51 comprises a polyurethane foam surfaced stainless steel roll, and the doctor roll comprises a knurled chrome-plated stainless steel roll. The applicator roll at coating station 50 applies the first electron beam curable polymer coating to the release film 55, with the total quantity of liquid resin deposition being, in some embodiments, about 10 to about 75 gsm. Alternatively (not depicted), a second coating station may instead apply a second electron beam curable polymer to the decorative paper immediately after the first electron beam curable polymer coating station.

After the decorative paper 30 has been coated with an electron beam curable polymer resin and the release film 55 has been coated with a second electron beam curable polymer resin, the coated decorative paper 30 and coated release film 55 are combined. The respective coatings in direct contact with each other when the decorative paper and release film 55 proceed to the electron beam curing station 45. After electron beam curing, the release film 55 is separated from the decorative paper 30. Because the release film 55 is not electron beam curable, the second electron beam curable polymer resin will cure and affix to the first electron beam curable polymer resin, and, therefore, the decorative paper, the release film 55 may be easily removed. The dual-polymer coated and electron beam cured decorative paper 30 is then combined with one or more webs of core paper 20 that have been impregnated with a resin that is substantially formaldehyde free, and the layer of decorative paper 30 and layers of core paper 20 proceed through a continuous press 60. Under sufficient pressure and heat, the resins in the individual laminate layers flow, cure and bond together, forming the consolidated, unitary substantially formaldehyde-free laminate 1 in accordance with an embodiment of the present invention.

It is noted that terms like “preferably,” “generally”, “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of making a substantially formaldehyde-free laminate comprising
providing at least one layer of decorative paper, wherein the decorative paper is substantially formaldehyde free;
applying at least one polymer coating that is substantially formaldehyde free onto at least one surface of the decorative paper;
electron beam curing the at least one polymer coating onto the decorative paper;
providing one or more layers of core paper onto the coated decorative paper, wherein the core paper is impregnated with a resin that is substantially formaldehyde free; and
hot pressing the core paper and coated decorative paper to form the substantially formaldehyde-free laminate.

2. The method of claim 1, further comprising pretreating the decorative paper by impregnating the decorative paper with a thermoset resin composition that is substantially formaldehyde-free.

3. The method of claim 2, wherein the thermoset resin composition comprises from about 10 to about 15% by weight of a composition selected from the group consisting of epoxy, vinyl ester, urethane, and combinations thereof.

4. The method of claim 1, wherein the at least one polymer coating comprises from about 10 to about 15 grams per square meter of thermoset acrylic, urethane, or combinations thereof.

5. The method of claim 4, wherein the at least one polymer coating comprises an Al₂O₃ abrasive.

6. The method of claim 5, wherein the at least one polymer coating comprises a thermoplastic copolymer resin.

7. The method of claim 1 wherein the at least one polymer coating comprises a first polymer coating and a second polymer coating disposed on the first polymer coating.

8. The method of claim 7 wherein the electron beam curing occurs after application of the first polymer coating and after the application of the second polymer coating.

9. A method of making a substantially formaldehyde-free laminate comprising
providing a layer of decorative paper, wherein the decorative paper is substantially formaldehyde free;
pretreating the decorative paper by impregnating it with a thermoset resin composition that is substantially formaldehyde free;
applying at least one polymer coating that is substantially formaldehyde free onto at least one surface of the pretreated decorative paper;
electron beam curing the at least one polymer coating onto the at least one surface of the decorative paper;
providing one or more layers of core paper, wherein the core paper is impregnated with an resin that is substantially formaldehyde free; and
hot pressing the core paper and coated decorative paper to form the substantially formaldehyde-free laminate.

10. The method of claim 9 wherein the at least one polymer comprises a first polymer coating and a second polymer coating disposed on the first coating.

11. The method of claim 10 wherein the first polymer coating comprises from about 10 to about 15 grams per square meter thermoset acrylic or urethane.

12. The method of claim 10 wherein the second polymer coating comprises a thermoplastic copolymer resin.

13. The method of claim 9, wherein the thermoset resin composition comprises from about 10 to about 15% by weight of a composition selected from the group consisting of epoxy, vinyl ester, urethane, and combinations thereof.

14. The method of claim 10, wherein the first polymer coating further comprises Al₂O₃ abrasive.

15. The method of claim 10, wherein the first and second polymer coatings are substantially identical in composition.

16. A substantially formaldehyde-free laminate comprising
at least one layer of decorative paper substantially free of formaldehyde and impregnated with a substantially formaldehyde-free thermoset resin;
one or more layers of kraft paper disposed on an inner surface of the decorative paper, wherein the kraft paper is impregnated with an resin that is substantially formaldehyde free; and
an electron beam cured polymer coating that is substantially formaldehyde free disposed on an outer surface of the decorative paper, wherein the electron beam cured polymer coating is an outermost layer of the substantially formaldehyde-free laminate.

17. The laminate of claim 16, wherein the thermoset resin composition comprises from about 10 to about 15% by weight of a composition selected from the group consisting of epoxy, vinyl ester, urethane, and combinations thereof.

18. The laminate of claim 16, wherein the at least one electron beam cured polymer coating comprises from about 10 to about 15 grams per square meter of thermoset acryclic, urethane, or combinations thereof.

19. The laminate of claim 18, wherein the at least one electron beam cured polymer coating comprises Al₂O₃ abrasive.

20. The laminate of claim 19, wherein the at least one electron beam cured polymer coating comprises a thermoplastic copolymer resin.
